(19) United States
(12) Patent Application Publication
(10) Pub. No.: US 2007/0020305 A1
(43) Pub. Date: Jan. 25, 2007

(54) Attractant for monitoring or controlling female stored product moths

(75) Inventors: Christian Nansen, Charlotte, NC (US); Charles Konemann, Stillwater, OK (US); Thomas W. Phillips, Stillwater, OK (US); Jack W. Dillwith, Stillwater, OK (US)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(73) Assignee: Board of Regents for Oklahoma State University

(21) Appl. No.: 11/056,677

(22) Filed: Feb. 11, 2005

Related U.S. Application Data
(60) Provisional application No. 60/543,711, filed on Feb. 11, 2004.

(51) Int. Cl. A01N 65/00; A01N 25/08

(52) U.S. Cl. 424/410; 424/750; 424/764

(57) ABSTRACT

A lure for attracting females of stored product moths comprising an cold hexane extract or a synthetic equivalent of an oily seed. The extract or equivalent comprises material such as single-chain or branched, saturated or unsaturated hydrocarbons, alcohols, aldehydes, and ketones. The extract includes extracts of nuts, chick starter and seeds. A method of attracting females of a population of stored product moths includes formulating a chemical extract of a material that is attractive to stored product moths into a lure. The extract or synthetic equivalent of an oily seed is formulated into a slow release device for use in attracting moths to a trap for monitoring or controlling populations of moths, for attracting moths to a killing station that is treated with a toxicant or pathogen for purposes of controlling populations of moths, and for confusing or disrupting moth behavior that results in controlling populations of moths.

### CROSS REFERENCE TO RELATED APPLICATION

This application claims the benefit of copending U.S. Provisional Patent Application Ser. No. 60/543,711 entitled ATTRACTANT FOR MONITORING OR CONTROLLING FEMALE STORED PRODUCT MOTHS filed Feb. 11, 2004.

### STATEMENT REGARDING FEDERALLY SPONSORED RESEARCH

The Government of the United States of America may have certain rights in this invention pursuant to Grant No. 00-51101-9674 awarded by the USDA CSREES RAMP and Grant No. 2003-34103-13919 awarded by the USDA CSREES Southern Regional Integrated Pest Management Program.

### FIELD OF THE INVENTION

This invention relates to the attraction of insects, particularly females of the Indianmeal moth, almond moth, Mediterranean flour moth and of other stored product moths, with attractive materials, extracts or synthetic chemical mixtures derived from animal feeds, grains, seeds and/or other mixtures of plant material. used to control insect populations through mating disruption (for review see Phillips et al. 2000) or as part of an attracticide (Nansen and Phillips 2004). However, both monitoring and control of stored product moths at the time of this application are exclusively focused on the male population, while the female population is unaffected by these approaches. Since one male can mate up to six females in a lifetime, a very large number of males need to be trapped and killed before reproduction in females is significantly affected (Brower 1975, Nansen and Phillips 2004). An attractant for female moths would target the egg-laying part of the population and therefore have a greater impact on a pest population than would the trapping of males.

Attractants for female stored product moths have not been reported or described to date, although some studies have reported materials that affect female behavior, and female attractants have been described for unrelated moth species. Barrer and Jay (1980) reported that odors from grain would induce upwind flight in Cadra (=Ephestia) cautella, although the chemical nature of this was not pursued, nor was the response of moths in natural settings. Phillips and Strand (1994) showed that larval food combined with secretions from larvae stimulated egg-laying by Indianmeal moth females. Similarly, Nansen and Phillips (2003) found that a variety of food and non-food oils stimulated egg-laying by Indianmeal moth, but there was no documentation of attraction to these oils over distance and the female moths had to contact the oil-treated substrate for maximum response. While describing attractants for female naval orangeworm moths, Amyelois transitella, a field pest and not a stored product moth, the inventors of U.S. Pat. No. 5,104,654, suggested that a mixture of free fatty acids attractive to naval orangeworms may also be attractive to stored product moths, but no data were provided to substantiate that (see also Phelan et al. 1991). Laboratory studies of close-range attraction suggested that ovipositing Indianmeal moth females may respond to free fatty acids (Nansen et al. 2003), but subsequent field studies have eliminated free fatty acids as long-range attractants for stored product moths. A bisexual attractant for the codling moth, a pest of apple and other tree fruits, was recently reported (U.S. Pat. No. 6,528,049) to be ethyl-decdienoate, but this compound is not attractive to stored-product moths. There were suggestions that various nuts and other ingredients in chocolate candies are attractive to storage moths (Hoppe 1981), but no chemical attractants were elucidated. Work with moths in the family Noctuidae has found that several short-chain alcohols and other degradation products of sugars, such as acetic acid, are attractive to both sexes (e.g. Landolt 2000). A recent study found that some of these noctuid attractants, specifically isoamyl alcohol and acetic acid, would attract females and males of the storage pests Indianmeal moth and Mediterranean flour moth (Toth et al. 2002). Chow et al. (1977) and Ryne et al. (2002) demonstrated that both sexes of several species of pyralid storage moths are attracted to water.

### SUMMARY OF THE INVENTION

The invention described here is of a concentrated chemical extract or dried ground material of either specific animal feeds, mixed seeds, nuts or other food products, or a synthetic chemical mixture of the volatiles from such food materials, that has the quality of attracting female moths belonging to species known to infest durable raw or processed food products, known as stored-product moths. The attractive materials, extracts or synthetic mixtures are characterized by containing several chemical compounds elaborated below and represented by single-chain or branched, saturated or unsaturated hydrocarbons, alcohols, aldehydes, ketones, and other volatiles typical of various plant extracts. The inventive attractants find use in insect traps to monitor the presence of certain pest species or to control or otherwise impact the population of a target pest by mass-trapping females, deploying the attractant in chemical or full physical form in killing stations or as an attracticide formulation of the attractant plus an insecticide or pathogen, or in any other way to manipulate or disrupt moth behavior that may result in population suppression.

### BACKGROUND OF THE INVENTION

The Indianmeal moth, Plodia interpunctella, is a serious pest of postharvest agricultural products, particularly stored grain, nuts, dried fruits, animal feeds, grain based food products, cocoa and various candies. Closely related species of moths in the family Pyralidae also infest stored-products and are considered as a pest complex worldwide that threatens these postharvest commodities. These additional species include the almond moth, Cadra cuatella, the Mediterranean flour moth, Ephestia kuehniella, the raisin moth, Ephestia figuliella, the tobacco moth, Ephestia ellutella, and the rice moth, Corcyra cephalonica. Collectively, these moth-species are referred to herein as “storage moths” or “stored product moths”.

Current pest management programs for stored product moths rely heavily on the ability to make early and spatially precise detection and monitoring of moth occurrence in a given food facility. Sticky traps containing an attractant is the standard procedure for monitoring of moth pest activity. Prior to this invention the only attractants available for storage moths were synthetic components of the female-produced sex pheromones that attract male moths only. Brady et al. (1970) reported that Z E-9, 12-tetradecadienyl acetate was the major pheromone component for the Indianmeal moth, and later this same pheromone was found to be common among many of the other closely related stored product moth species (Burkholder and Ma 1984). In addition to monitoring and detection, female-produced sex pheromones of stored product moths are also being

### DESCRIPTION OF THE PREFERRED EMBODIMENTS

Before explaining the present invention in detail, it is important to understand that the invention is not limited in its application to the details of the embodiments and steps described herein. The invention is capable of other embodiments and of being practiced or carried out in a variety of ways. It is to be understood that the phraseology and terminology employed herein is for the purpose of description and not of limitation.

The present invention will be further understood with reference to the following non-limiting experimental examples.

### EXAMPLE 1

In the course of conducting research on populations of the Indianmeal moth we deployed dishes filled with larval rearing diet into buildings infested with moths, and we monitored the level of moth activity by the number of eggs laid in dishes containing about 20 grams of rearing diet. The rearing diet we used was composed volumetrically of 2 parts ground corn meal, 1 part chick starter mash, 1 part egg-laying crumbles (each of which is a conventional chicken food) and about 1.5 parts glycerin to provide moisture, all mixed by hand to a uniform consistency. By placing diet dishes in different part of the room exposed to different air currents it became obvious that dishes at the upwind end of the room received more eggs than did dishes at the downwind end, which suggested that female moths were flying upwind to odors of the larval rearing diet.

### EXAMPLE 2

A series of controlled experiments were then conducted to elucidate the nature of the attraction to rearing diet and other material. Unless otherwise stated, experiments were conducted using two to four rooms with floor areas of 200-600 square feet each and ceiling heights of 8-10 feet. Rooms were maintained at abut 22-25° C. 30-50% relative humidity, and were either totally darkened or had the lights turned off at night time. Other studies determined that Indianmeal moth females fly and lay eggs at night time or in the dark. Groups of 50-200 laboratory-reared Indianmeal moth adults of mixed sex were released into each room at the start of an experiment and additional similar groups of moths were subsequently released each time an experiment was replicated, usually every two to three days. Moths used in these experiments were reared on a wheat-based diet to avoid any possibility that lab-reared moths had an acquired preference for the corn-based foods we were testing. Experiments compared the number of female moths that were caught in sticky insect traps baited with test material. Traps were hung from the ceiling at a height of about 7 feet, and were spaced at least 8 feet apart. We conducted experiments as randomized complete block designs in which a group of traps together constituted one block, and each treatment in the experiment was assigned randomly once to each trap in a block. Females were distinguished from males by the sex-specific genitalic structures protruding from the distal end of the abdomen. Experiments either compared the attractiveness of whole ground food material or of chemical extracts of ground food material.

### EXAMPLE 2A

The first experiment compared the whole ground dry ingredients of the Indianmeal moth rearing diet: corn meal, chick starter and egg crumbles. Food materials were ground in a blender so that they passed through U.S. sieve no. 14 and then were formed into disk-shaped wafers containing 20 g of food and formulated with water and agar to hold shape (approximately 1 cm high and 5.5 cm in diameter). A single wafer was placed on the center of the bottom sticky panel in each trap. Five different treatments were compared: the three diet components together in one wafer, egg crumbles only, chick starter only, corn meal only, and an untreated control which was composed of cellulose, water and agar. After 10 blocks of traps (replicates) were run the following results were obtained.

| Treatment | Mean No. Females per Trap |
|---|---|
| combination | 5.6 |
| egg crumbles | 4.3 |
| chick starter | 5.1 |
| corn meal | 1.7 |
| cellulose control | 0.4 |

All four treatments with food were significantly more attractive than controls, but the combined diet, egg crumbles and chick starter were statistically similar in attractiveness and each of these were more attractive than corn meal alone. Subsequent experiments conducted with these same components in this way consistently showed that egg crumbles and chick starter accounted for the attraction of females to our laboratory larval rearing diet. Although there were never statistical differences between chick starter and egg crumbles in their relative attractiveness, we chose to pursue and refine the attractiveness of chick starter because it was composed of essentially the same ingredients as egg crumbles and it was slightly less expensive to purchase. Chick starter in all our studies was obtained from a local feed mill and was composed of the following major ingredients: ground corn (40%), soybean meal (16.5%), wheat midds (30%), alfalfa meal (7.5%), tallow (1.6%), and about 7% of various minerals and vitamins.

### EXAMPLE 2B

During the course of our other studies we observed that our laboratory rearing diet would attract female stored product moths even in environments containing potentially competing attractive foods, such as pet foods, bird seeds and nuts. These observations led us to suspect that the attractive component in the diet was more attractive than other foods infested by storage moths. Thus we conducted a controlled experiment using agar wafers of the following dried foods: chick starter, dog food, bird seed and an untreated cellulose control. All wafers had 20 g of ground dried food. The bird seed tested was a mixture of white proso millet seeds, milo, wheat and sunflower seeds. The dog food was chunk-style regular Purina dog chow. After 8 experimental blocks were run (8 replicates) on four separate days, we obtained the following overall results.

| Treatment | Mean No. Females per Trap |
|---|---|
| Chick Starter | 7.8 |
| Bird seed | 8.8 |
| Dog Food | 5.5 |
| Cellulose Control | 0.3 |

Each of the three foods caught significantly more female moths than did control traps. The most attractive materials were chick starter and bird seed, which were statistically similar to each other and each more attractive than dog food.

### EXAMPLE 2C

We conducted further studies on ground whole nuts since our earlier work (Nansen and Phillips 2003) showed that oils from nuts elicited close range egg-laying behavior, and the suggestion by Baker and Phelan (patent) that nuts should be attractive to female stored product moths. The following treatments were compared in a controlled trapping experiment, all at 20 g of ground materials in agar wafers: chick starter, pecan, peanut, walnut, sunflower and a cellulose control. Four randomized blocks of traps were run on six different days, and the overall results were as follows.

| Treatment | Mean no. Females per Trap |
|---|---|
| Chick Starter | 10.9 |
| Peanut | 8.7 |
| Sunflower | 5.3 |
| Walnut | 4.9 |
| Pecan | 4.2 |
| Cellulose control | 0.4 |

Each of the food materials was significantly more attractive to female moths than the cellulose control. Chick starter was statistically similar in attractiveness to peanuts, and each of these two were more attractive than sunflower, walnut and pecan, which formed a group that were statistically similar in attractiveness.

### EXAMPLE 2D

An additional study was done with ground almond nuts to determine the level of attractiveness relative to chick starter; and we found that almond was no more attractive than chick starter or other nuts. Experiments using just the oils of nuts, such as those oils that elicited contact or close-range egg-laying response by Indianmeal moth in Nansen and Phillips (2003), were also tested and found to be unattractive and similar to a blank control in traps.

Results up to this point indicated that certain chicken foods, primarily chick starter and eggs crumbles, mixed bird seeds, peanuts and potentially other seeds and nuts represent attractants for female stored product moths, and that as such represent the core of the invention here for attracting and manipulating moth populations. Thus ground foods, represented by oily seeds and nuts, could be used as attractants or attracticides (combining the attractant with a killing or disease agent, as in Nansen and Phillips 2004) to monitor, manipulate or suppress populations of stored product moths.

### EXAMPLE 3

Subsequent experiments investigated the ability to extract the attractive components of chick starter into an organic solvent so it could be further used in a convenient way other than as whole ground food (although whole ground food alone represents one embodiment of the invention), and to provide an active solution for chemical characterization. We chose to test three different organic solvents that are commercially available, commonly used in food chemistry, and represent a range of polar affinities: hexane, dichloro-methane (methylene chloride) and methanol (methyl alcohol or wood alcohol). For each solvent, we extracted 200 grams of ground chick starter in 1000 ml of solvent at room temperature for 24 hrs. Preliminary extractions and bioassays suggested that this would be an optimal extraction ratio and 24 hours was adequate for extraction. Following extraction the residue was filtered from the extracts and each extract was concentrated to 50 ml using a rotary evaporator. A 5 ml aliquot of concentrated extract was applied to a 4 cm piece of cotton dental roll to serve as a slow release wick device for the attractant. Thus each cotton wick contained an amount of extract equivalent to 20 grams of chick starter, and thus would be comparable to the use of 20 g of whole chick starter in our previous experiments. Cotton wicks were deployed into sticky traps in tests for attractiveness in our experimental rooms along with untreated cotton wicks as controls. Results were as follows.

| Treatment | Mean No. Female per Trap |
|---|---|
| Hexane extract | 4.2 |
| Methanol extract | 4.3 |
| Dichloromethane extract | 2.4 |
| Blank control | 0.2 |

All three extracts were statistically similar in attractiveness to female moths, and each was significantly more attractive than a blank cotton wick.

### EXAMPLE 4

Hexane was chosen for subsequent work because it was as effective as other solvents and was relatively easy to work with during the concentration phase. Since the initial extractions were done at room temperature we assumed we could extract more active material in a hot extraction process. Before proceeding with hot extraction, we tested the liability of the attractant when exposed to heat with the following experiment. A cold hexane extraction was conducted as described above. The extract was concentrated and then divided in half volumetrically. One half was retained in a glass container at room temperature, the other was immersed in a hot water bath of 80° C. and held for 3 hrs. After the heating, 5 ml of each extract were applied to separate cotton wicks and these were deployed into traps for testing, along with traps containing blank cotton wicks as controls. Results were as follows.

| Treatment | Mean No. Females per Trap |
|---|---|
| Cold hexane extract | 6.4 |
| Heated hexane extract | 2.0 |
| Blank Control | 0 |

Attraction of moths to the heated hexane extract was significantly lower than to cold extract, which suggested that heating would degrade or somehow alter the attractive components of the chick starter extract. Thus our invention includes a cold solvent extraction of attractive food materials. All subsequent development work utilized cold hexane extraction with the general methods described so far.

The concentrated hexane extract of chick starter food represents the most processed state of the invention, with extracts of other similar foods using hexane or other solvents, the whole un-extracted foods themselves, and synthetic mixtures of volatile chemical components of these foods evaporated from appropriate slow-release formulations representing other aspects of the invention.

### EXAMPLE 5

We subsequently determined the longevity of attractiveness of chick starter extract by conducting an aging study with the material. A cold hexane extract of 200 grams in 1000 ml of hexane was prepared as described above, and 20-gram equivalents of the extract were applied to cotton wicks and deployed in traps with blank control traps and assessed for levels of activity against an Indianmeal moth population every week for eight weeks. Results are presented here.

Mean No. Female per Trap in a Given Week

| Treatment | wk 1 | wk 2 | wk 3 | wk 4 | wk 5 | wk 6 | wk 7 | wk 8 |
|---|---|---|---|---|---|---|---|---|
| Blank Control | 0.8 | 0.3 | 0.5 | 0 | 0 | 0.5 | 0.8 | 1.0 |
| Chick Starter | 1.8 | 8.8 | 3.0 | 4.5 | 3.0 | 5.5 | 4.8 | 10.5 |
| Extract | | | | | | | | |

These results clearly show that the chick starter extract was consistently more attractive to female storage moths compared with a blank control, and the attractiveness of the cotton wicks treated with the extract remained active for up to 8 weeks under normal room conditions.

### EXAMPLE 6

We conducted two subsequent experiments to test the activity of the chick starter extract against species of pest stored-product moths other than Indianmeal moth. The first experiment was with the Almond Moth, Cadra cautella, the second was with the Mediterranean flour moth, Ephestia kuehniella. Moths of both species were maintained in separate laboratory rearing colonies. For each week-long experiment, several hundred mixed sex adults were released into a large room with 10 sets of paired traps, one trap baited with a cotton wick containing the chick starter extract as described above, and the other trap being an unbaited control. Results for female captures in the two experiments were as follows.

| Species | Mean No. to Extract | Mean No. to Blank |
|---|---|---|
| Almond Moth | 3.7 | 0.3 |
| Med. Flour Moth | 1.9 | 0.3 |

There was a statistically significant response of females of these two species to chick starter extract compared to blank traps. No males of these species were trapped. Thus the attractant has utility in attracting females of the almond moth and Mediterranean flour moth.

### EXAMPLE 7

In order to chemically characterize the nature of the attractant associated with cold hexane extracts of chick starter, birdseed and peanuts, we analyzed the volatile chemicals emanating from cotton wicks on which 5 ml of 20-gram equivalent extracts of each material had been separately applied. Thus, such a cotton wick would be similar to those used in experiments above that were attractive to female moths. A wick was prepared as explained above and placed in a 100 ml glass vessel with an opening at each end designed for collecting headspace volatiles from small preparations. One opening was connected to a glass filtering tube containing 100 mg of Super-Q solid phase adsorbent polymer for the purposes of trapping volatile chemicals from the headspace surrounding the cotton wick. Clean air was drawn through the other opening, over the treated cotton wick, and through the Super-Q column using a vacuum pump for 24 hours at a flow rate of approximately 100 ml per minute. Trapped compounds on the Super-Q column were eluted in 1.0 ml of hexane, which was then concentrated to about 200 micro liters, and this solution was analyzed using coupled gas chromatography-mass spectrometry (GC-MS). We used a 30 meter RTX-35 capillary column in the GC and MS analysis was conducted in electron impact mode. The temperature program on the GC column oven was 40° C. for 60 sec., then 20 degrees a minute to 60° C., then 5 degrees a minute to 200° C., then 20° C. per minute to 280° C. and hold for 5 minutes.

The identities of the most abundant compounds from these three materials were determined and are given in the table below according to their retention time on the RTX-35 column. The majority of these compounds are shared in common by the three attractive materials that we studied, and thus points to the commonality of these chemical attractants among similar food materials. In the below table, compounds identified by GC-MS from extracts of the attractive materials chick starter (CS), bird seed (BS) and peanuts (PN) are listed in order of elution and retention time (RT) in minutes from the GC column.

| | | | Presence | | |
|---|---|---|---|---|---|
| | | | in Given | | |
| | | | Extract | | |
| Cmpd No. | Name | RT | CS | BS | PN |
| 1 | 3-Hexanol | 6.64 | X | X | X |
| 2 | 2-Hexanol | 6.71 | X | X | X |
| 3 | 3-Hexanone | 6.89 | X | X | X |
| 4 | 2-Hexanone | 7.04 | X | X | X |
| 5 | Hexanal | 7.34 | X | X | X |
| 6 | 1-Hexanol | 8.79 | X | X | X |
| 7 | 1-octene-3-ol | 12.05 | X | | X |
| 8 | E-2-Heptenal | 12.35 | X | X | |
| 9 | Limonene | 13.34 | X | X | |
| 10 | Nonanal | 16.44 | X | X | |
| 11 | Dodecane | 16.72 | X | | |
| 12 | 1-Nonanol | 18.17 | X | | X |
| 13 | Phenylethyl alcohol | 19.27 | X | X | X |
| 14 | Tridecane | 19.71 | X | X | |

Numerous other compounds detected in lower amounts were isomeric variants of these listed. These same compounds discussed here are typical of the flavor and aroma chemicals generated from crushed seeds of various types, cereal grains and various nutmeats (e.g. Vercolotti et al. 1992). Thus the invention is further defined as a chemical extract of chicken foods, mixed seeds or nuts characterized by volatile chemical including, but not limited to straight chain or branched hydrocarbons, alcohols, aldehydes, ketones, phenolics, terpenoids,or a synthetic mixture of such chemicals, that is attractive to female stored-product moths.

As a result of the above experiments considered in total, we have invented an attractant for females of the Indianmeal moth, Plodia interpunctella, the almond moth, Cadra cautella, the Mediterranean flour moth, Ephestia kuehniella and females of other stored product moths, including but not limited to Ephestia ellutella, Ephestia figuliella, Corcyra cephalonica and Sitotroga cereallela, that is a chemical extract of either chicken food, mixed seeds, various nuts, or similar oily seed-based foods, or the raw foods themselves, or a synthetic blend of volatiles like those listed above making up the flavor profiles of such foods, that is concentrated and used in a trap or killing station or broadcast in some formulation to confuse or disrupt moth behavior, either for the purpose of attracting, monitoring, controlling or manipulating populations of such moths species for the purpose of pest control or pest management.

Various modifications of the invention as above described will be obvious to those skilled in the art and can be resorted to without departing from the spirit and scope of the invention as defined here.

Thus, the present invention is well adapted to carry out the objects and attain the ends and advantages mentioned above as well as those inherent therein. While presently preferred embodiments have been described for purposes of this disclosure, numerous changes and modifications will be apparent to those skilled in the art. Such changes and modifications are encompassed within the spirit of this invention as defined by the appended claims.

What is claimed is:

1. A lure for attracting females of stored product moths comprising an extract or a synthetic equivalent of an oily seed.

2. The lure according to claim 1 wherein:
said lure comprises a cold hexane extract.

3. The lure according to claim 1 wherein said extract comprises:
a material selected from a group consisting of single-chain or branched, saturated or unsaturated hydrocarbons, alcohols, aldehydes, and ketones.

4. The lure according to claim 1 wherein said synthetic equivalent comprises:
compounds selected from a group consisting of single-chain or branched, saturated or unsaturated hydrocarbons, alcohols, aldehydes, and ketones.

5. The lure according to claim 1 wherein said extract of an oily seed comprises:
an extract of nuts comprised of at least one compound selected from the group consisting of 3-Hexanol, 2-Hexanol, 3-Hexanone, 2-Hexanone, Hexanal,1-Hexanol, 1-octene-3-ol, E-2-Heptenal,Limonene, Nonanal, 1-Nonanol, Phenylethyl alcohol, Tridecane.

6. The lure according to claim 1 wherein said extract of an oily seed comprises:
an extract of chick starter comprised of at least one compound selected from the group consisting of 3-Hexanol, 2-Hexanol, 3-Hexanone, 2-Hexanone, Hexanal,1-Hexanol, 1-octene-3-ol, E-2-Heptenal,Limonene, Nonanal, Dodecane 1-Nonanol, Phenylethyl alcohol, Tridecane.

7. The lure according to claim 1 wherein said extract of an oily seed comprises:
an extract of seeds comprised of at least one compound selected from the group consisting of 3-Hexanol, 2-Hexanol, 3-Hexanone, 2-Hexanone, Hexanal,1-Hexanol, E-2-Heptenal, Limonene, Nonanal, 1-Nonanol, Phenylethyl alcohol, Tridecane.

8. A method of attracting females of a population of stored product moths comprising the steps of:
formulating a chemical extract of a material that is attractive to stored product moths into a lure, said material selected from the group consisting of an extract or synthetic equivalent of an oily seed.

9. The method according to claim 8 wherein:
said oily seed comprises a ground chick starter;
said method further comprising the steps of:
extracting said ground chick starter in a solvent for a period of time;
filtering residue from extracts of said ground chick starter;
concentrating said extracts;
applying said extracts to a slow release device for evaporation of said extracts.

10. The method according to claim 8 wherein:
said extract or synthetic equivalent of an oily seed is formulated into a slow release device for use in attracting moths to a trap for monitoring or controlling populations of moths.

11. The method according to claim 8 wherein:
said extract or synthetic equivalent of an oily seed is formulated into a slow release device for use in attracting moths to a killing station that is treated with a toxicant or pathogen for controlling populations of moths.

12. The method according to claim 8 wherein:
said extract or synthetic equivalent of an oily seed is formulated into a slow release device to broadcast the attractants for use in confusing or disrupting moth behavior for controlling populations of moths.

13. The method according to claim 9 wherein:
said step of extracting ground chick starter in a solvent comprises extracting approximately 200 grams of said chick starter in approximately 1000 ml of solvent.

14. The method according to claim 8 wherein:
said oily seed comprises a chick starter formula comprising:
40% ground corn;
16.5% soybean meal;
30% wheat midds;
7.5% alfalfa meal;
1.6% tallow; and
7% minerals and vitamins.

15. The method according to claim 8 wherein said oily seed comprises a chick starter formula comprising:
2 parts ground corn meal;
1 part chicken starter mash;
1 part egg laying crumbles;
1.5 parts glycerin.

16. The method according to claim 8 wherein said oily seed comprises a mixture comprising:
white proso millet seeds;
milo;
wheat; and
sunflower seeds.

17. The method according to claim 8 further comprising the step of extracting a volatile chemical from said material, wherein said volatile chemical is selected from a group consisting of straight chain and branched hydrocarbons, alcohols, aldehyes, ketones, phenolics terpenoids and a synthetic mixture of said volatiles.
